(19) United States
(12) Patent Application Publication
(10) Pub. No.: US 2012/0164204 A1
(43) Pub. Date: Jun. 28, 2012

(54) ENCAPSULATION USING WAX-TYPE SUBSTANCES

(75) Inventors: Holger Egger, Koln (DE); Dirk Storch, Koln (DE)

(73) Assignee: Bayer Technology Services GMBH, Leverkusen (DE)

(21) Appl. No.: 13/392,938

(22) PCT Filed: Sep. 10, 2010
(86) PCT No.: PCT/EP2010/063328

§ 371 Date: Feb. 28, 2012

(30) Foreign Application Priority Data
Sep. 15, 2009 (EP) 09011748.2

(51) Int. Cl. A01N 25/28; A01N 37/34; A01P 7/04; A01N 25/08

(52) U.S. Cl. 424/408; 514/521

(57) ABSTRACT

Method for producing stable capsules which comprises the steps of providing a first component comprising a wax-like substance and a second component comprising a substance to be encapsulated, dissolved or dispersed in a liquid medium, homogeneously mixing the first and second components, dispersing the mixture in an aqueous solution using at least one dispersion auxiliary at a temperature above the melting point of the wax-like substance to prepare a microemusion, and cooling and diluting the microemulsion.

This is a 371 of PCT/EP2010/063328 filed Sep. 10, 2010 (international filing date), claiming priority of European application 09011748.2, filed Sep. 15, 2009.

The present invention relates to the field of encapsulation of substances. The invention provides capsules, the core of which comprises a hydrophobic, wax-like substance, and also dispersions comprising the capsules according to the invention. The present invention further provides the use of capsules according to the invention for encapsulating substances, a method for producing capsules according to the invention, and also the use of hydrophobic, wax-like substances for the mechanical and/or chemical stabilization of capsules.

### BACKGROUND OF THE INVENTION

A capsule is a solid body which serves to accommodate a substance. The mostly homogeneous body of a matrix capsule provides a structure (a matrix) in which a substance can be accommodated. In the case of core-shell capsules, the mostly homogenous core forms the matrix for accommodating substances and is surrounded by a solid shell.

The encapsulation of substances such as, for example, active ingredients plays an important role for example in producing drugs. As a result of the encapsulation, active ingredients are converted to a form in which they can be better supplied to the body of a living being. Furthermore, as a result of an encapsulation, a time-delayed release of an active ingredient within the body of the living being can be achieved.

Capsules are often referred to according to their size e.g. as microcapsules or nanocapsules, with the transition between microcapsules and nanocapsules being liquid.

The shell of core-shell capsules is often formed by a polymer. By way of example, mention may be made of core-shell capsules with a polyalkyl cyanoacrylate shell. They can be produced for example in aqueous phase by anionic polymerization of an alkyl cyanoacrylate at a low pH in the presence of a steric stabilizer (S. J. Douglas et al.: Particle Size and Size Distribution of Poly(butyl)-2-cyanoacrylate) Nanoparticles, Journal of Colloid and Interface Science, Vol. 101, No. 1, 1984, pages 149-158).

The accommodation of substances in the core of the capsules can take place, for example, as early as during the polymerization by dissolving the substances in the polymerization medium beforehand.

T. Pitaksuteepong et al. describe a synthesis of active-ingredient-containing cyanoacrylate capsules by polymerization at the interfaces of a water-in-oil microemulsion. The hydrophilic active ingredients are dissolved in the aqueous phase; as a result of the polymerization at the water/oil interface, the active ingredients are enclosed in the aqueous droplets (T. Pitaksuteepong et al.: Factors influencing the entrapment of hydrophilic compounds in nanocapsules prepared by interfacial polymerisation of water-in-oil microemulsions, European Journal of Pharmaceuticals and Biopharmaceuticals 53 (2002) pages 335-342).

In the case of hydrophobic active ingredients, a corresponding encapsulation takes place by interfacial polymerization in an oil-in-water emulsion (see e.g. M. Wohlgemuth et al.: Improved preparation and physical studies of polybutylcyanoacrylate nanocapsules, J. Microencapsulation, 2000, Vol. 17, No. 4, pages 437-448).

Capsules produced in this way have, at room temperature (20° C..), a solid shell and a liquid core. They are very sensitive to mechanical stress; the shell can break easily, which results in leakage from the capsules.

For the aforementioned application of capsules for accommodating, for example, active ingredients, however, it is required that the capsules are stable and can be stored and processed without becoming damaged to a noteworthy extent.

EP0526666A1 describes microspheres which consist of a wax or wax mixture in which active substances may be present. They are produced by dispersing a molten wax, which can comprise an active substance, together with surfactants in an aqueous phase above the melting temperature of the wax, and producing a microemulsion. After cooling the emulsion, the emulsion droplets are produced as solid microspheres.

EP0526666A1 does not disclose that the microspheres carry a further shell. Since the wax is solid under the conditions under which the microspheres are used, evidently no further stabilization of the capsules is required. The wax capsules are sufficiently stable.

However, there are substances which are to be encapsulated and are insoluble or only inadequately soluble in a wax. Such substances can accordingly only be encapsulated in core-shell capsules where the substances are dissolved in a suitable liquid solvent. As described above, such capsules have a reduced stability.

Moreover, there are substances which have an increased temperature sensitivity. Dissolving or dispersing substances in hot molten wax can damage them.

The object of the present invention is therefore to provide stable capsules. The capsules should be able to accommodate lipophilic substances and be storable and also processible without the capsules and/or the accommodated substances becoming damaged to a noteworthy extent as a result. The capsules should be suitable in particular for accommodating substances which do not dissolve, or dissolve only to an inadequate extent, in a wax or which have an increased temperature sensitivity. Furthermore, the capsules should be able to be produced on an industrial scale under economic conditions. A further object therefore consists in the provision of an economic method for producing stable capsules which can be carried out on an industrial scale.

### SUMMARY OF THE INVENTION

Surprisingly, it has been found that core-shell capsules with a hydrophobic liquid core can be mechanically and/or chemically stabilized by adding a hydrophobic wax-like substance.

The present invention therefore firstly provides the use of one or more wax-like substances for increasing the mechanical and/or chemical stability of capsules and/or encapsulated substances.

A wax-like substance is understood as meaning a substance which is hydrophobic, is solid under standard conditions and converts to the melt-liquid state below a temperature of 100° C.. at standard pressure, or dissolves in a liquid, hydrophilic substance below a temperature of 100° C.. at standard pressure.

Wherever the term solid or liquid is used below, this is always to be understood as meaning the aggregate state under standard conditions.

Standard conditions (NTP=Normal Temperature and Pressure) are understood as meaning the following conditions:
Standard pressure p=1.01325 bar=101325 Pa
Standard temperature T=298.15 K and here the air density p=1.184 kg/m³

### DETAILED DESCRIPTION

Suitable wax-like substances are, for example, the substances known under the term waxes. According to the definition in Römpp Chemie Lexikons (9th Edition, Georg Thieme Verlag Stuttgart, Volume T-Z, page 4972), a wax is understood as meaning a substance which is kneadable to 20° C.., solid to brittlely hard, coarse to finely crystalline, translucent to opaque, but not glass-like, melts without decomposition at temperatures above 40° C.., and is of relatively low viscosity and is non-thread-drawing even a little above the melting point. Furthermore, a wax exhibits a heavily temperature-dependent consistency and solubility and can be polished under light pressure.

Waxes differ from similar (synthetic or natural) products (e.g. resins, plastic masses, metal soaps and others) primarily in the fact that they generally convert to the melt-liquid, low-viscosity state approximately between 50° C.. and 90° C.., in exceptional cases also up to about 200° C.., and are virtually free from ash-forming compounds.

In Römpp Chemie Lexikon (see above), various representatives of waxes are listed by way of example on page 4972 in a table. Examples of waxes are esters of fatty acids with long-chain (more than 24 carbon atoms), aliphatic, primary alcohols (e.g. spermaceti, beeswax, carnauba wax), earth waxes (e.g. ozokerite, kenderbal, neftgil) and paraffins.

The substances to be encapsulated are preferably active ingredients or detection agents.

An active ingredient is understood as meaning a substance which can interact with a biological system and can bring about a change in or on the biological system. Examples of active ingredients are drugs, herbicides, insecticides or fungicides.

A detection agent is understood as meaning a substance which displays a characteristic response to an external influence. Preferably, the detection agents accumulate at a certain point in an organism where they can be detected by chemical or physical methods. By way of example, fluorescent markers may be listed; upon irradiation with electromagnetic radiation of certain wavelengths, these emit for their part electromagnetic radiation with a characteristic wavelength pattern. A further example of a detection agent is radionuclides.

The substance to be encapsulated is usually required only in a small amount and is therefore usually present in dissolved or dispersed form in a suitable medium. Irrespective of whether the substance to be encapsulated is present in dissolved or dispersed form in a medium and irrespective of whether the substance to be encapsulated is an active ingredient or a detection agent, the medium comprising one (or more) substances to be encapsulated is referred to below as active ingredient dispersion.

An active ingredient dispersion is usually liquid under standard conditions and, for the encapsulation, is converted to fine droplets in accordance with the prior art; said droplets are provided with a solid shell. This results in the core-shell capsules known according to the prior art.

According to the invention, these core-shell capsules are mechanically and/or chemically stabilized by adding one or more wax-like substances. The result of adding a wax-like substance to the active ingredient dispersion is that this dispersion, which is otherwise liquid under standard conditions, following the addition of the wax-like substance has an increased viscosity or even becomes solid under standard conditions and thus has an increased stability. The increased viscosity or even solidity leads to a more mechanically stable matrix in which the substances to be encapsulated are embedded.

The wax-like matrix protects the embedded substances moreover against chemical and/or physical damage, for example against oxidation or damage by UV radiation.

Surprisingly, the stability as a result of adding the wax-like substance is so high that in some cases it is possible to dispense with a shell. However, there are also cases in which, although a shell is not required, or is no longer required, for reasons of stability, it is advantageous for reasons of better adhesion of capsules according to the invention to substrates (see below).

The choice of wax-like substance is governed by the active ingredient dispersion present. The wax-like substance should be homogeneously miscible with the active ingredient dispersion. The wax-like substance should not have a negative influence on the solubility/dispersibility of the substance to be encapsulated in the medium present.

Good results were achieved for a series of active ingredient dispersions with paraffins, fatty alcohols, fatty acids, fatty acid esters, fatty acid ethers, polyethylene waxes, montan waxes, polyether waxes and primarily beeswax, cetyl alcohol and Luwax E (montanic acid ester, BASF SE, Germany) as wax-like substances. It is also conceivable to use a plurality of waxes.

Based on the sum of the substances used for forming the capsules, the concentration of the wax-like substance used is in the range from 0.01 to 100% by weight, preferably in the range from 1 to 30% by weight, particularly preferably in the range from 5 to 15% by weight.

It is described in more detail below how capsules with one or more wax-like substances can be produced. This method for producing stable capsules using one or more wax-like substances is likewise provided by the present invention. The method according to the invention comprises at least the following steps:
(a) provision of a first component at least comprising one solid wax-like substance,
(b) provision of a second component at least comprising a substance to be encapsulated, dissolved or dispersed in a liquid medium,
(c) homogeneous mixing of the first and the second component,
(d) dispersion of the mixture from step (c) in an aqueous solution at a temperature above the melting temperature of the wax-like substance using at least one dispersion auxiliary, during which an emulsion, preferably a microemulsion, is formed,
(e) cooling and dilution of the emulsion from step (d)
(f) optionally: coating of the emulsified particles with a polymer shell.

Preferably, steps (a) to (f) are carried out in the stated order.

The concentration of the encapsulated substance is dependent on the substance used and the intended use. If active ingredients such as, for example, deltamethrin, flumethrin, clotrimazole, bifonazole and/or transfluthrin are used as substances, the concentration, based on the weight of the capsule, is in the range from 0.01 to 50% by weight, preferably in the range from 1 to 30% by weight, particularly preferably in the range from 5 to 15% by weight.

As a rule, the components from steps (a) and (b) are mixed at a temperature above the melting temperature of the wax-like substances used before the mixture is dispersed in an aqueous solution.

The liquid medium in which a substance to be encapsulated is dissolved or dispersed is a hydrophobic substance which is liquid under standard conditions, or a corresponding substance mixture.

The choice of liquid medium is governed by the substance to be encapsulated and the selected wax-like substance. All of the substances used should be homogeneously miscible with one another. In addition, the mixture should be solid under standard conditions.

Suitable liquid media are, for example, oils, to which one or more solvents such as, for example, alcohols can be added. According to the definition in Römpp Chemie Lexikons (9th Edition, Georg Thieme Verlag Stuttgart, Volume TM-Pk, page 3094), an oil is understood as meaning an organic substance which is water-insoluble and liquid at room temperature. Examples are mineral oils which are obtained from petroleum, synthetic oils such as e.g. silicone oil, triglycerides of medium saturated or unsaturated fatty acids (vegetable and animal fatty oils).

Good results have been achieved with liquid fatty acid esters such as, for example, Miglyol 812 (Caesar & Loretz GmbH, Germany), a mixture of decanoyl and octanoyl glycerides, and also aliphatic and aromatic hydrocarbons and hydrocarbon mixtures such as, for example, Solvesso-200 (CAS No. 64742-94-5, F. B. Silbermann GmbH& Co KG).

In step (d), the homogeneous hydrophobic mixture is dispersed in an aqueous solution using one or more dispersion auxiliaries at a temperature above the solidification point of the mixture. The dispersion auxiliaries used are usually surfactants. It is possible to use ionic (cationic, anionic, zwitterionic) and nonionic surfactants as dispersion auxiliaries. Amphiphilic block copolymers can also be used.

Examples of suitable dispersion auxiliaries are alkoxylates, alkylolamides, esters, amine oxides, alkyl polyglucosides, alkylphenols, arylalkylphenols, water-soluble homopolymers, random copolymers, block copolymers, graft polymers, polyethylene oxides, polyvinyl alcohols, copolymers of polyvinyl alcohols and polyvinyl acetates, polyvinylpyrrolidones, cellulose, starch, gelatine, gelatine derivatives, amino acid polymers, polylysine, polyaspartic acid, poly(meth)acrylates, polyethylenesulfonates, polystyrenesulfonates, condensation products of aromatic sulfonic acids with formaldehyde, naphthalenesulfonates, lignosulfonates, copolymers of acrylic monomers, polyethyleneimines, polyvinylamines, polyallylamines, poly(2-vinylpyridines) and/or polydiallyldimethylammonium chloride. Mixtures of different dispersion auxiliaries can also be used.

Preference is given to using polyoxyethylene-polyoxypropylene block copolymers such as, for example, Synperonic F68 (trade name of ICI, Great Britain) and/or a copolymer with pigment-affinic groups such as, for example, Disperbyk-192 (BYK-Chemie GmbH, Germany).

The dispersion auxiliary is preferably dissolved in the aqueous phase before the hydrophobic mixture is added. The concentration of the dispersion auxiliary in the aqueous phase is in the range from 0.1-50% by weight, preferably in the range from 1-30% by weight.

Preferably, the liquid hydrophobic mixture is added to the aqueous phase with stirring. It is conceivable to assist the dispersion through the use of Ultra-Turrax or ultrasound. The use of high energy inputs by means of Ultra-Turrax or ultrasound, however, is not necessary and is also somewhat undesirable for a process on an industrial scale. As a result of increasing the concentration of the dispersion auxiliary, the dispersion is also possible with customary stirring.

In step (e), the emulsion is diluted and cooled to a temperature between 0° and 30° C.. in order to avoid coalescence of the hydrophobic droplets and particle growth. By means of routine experiments, in each individual case it is possible to determine to what temperature the emulsion has to be cooled and what dilution is required in order to avoid coalescence of the hydrophobic droplets and particle growth.

The dilution takes place preferably in the ratio water:emulsion of 1:1 to 10:1. The cooling takes place preferably to a temperature below the solidification point of the mixture which forms the particles. The cooling and/or dilution preferably takes place rapidly, “rapidly” being understood as meaning that the dilution and/or cooling takes place without avoidable delay in the shortest time which can be realized technically and under economic conditions and also with regard to the required safety provisions.

It is e.g. conceivable to add the heated emulsion with stirring in water at a temperature between 0° and 30° C.. in order to achieve dilution and cooling.

The result is an aqueous dispersion of solid, mostly spherical particles with a maximum diameter of less than 1 μm, preferably of less than 0.5 μm, particularly preferably of less than 0.25 μm. The maximum diameter, averaged arithmetically over a large number of particles, is in the range from 20-200 nm, preferably in the range from 50-120 nm. The diameter can be determined for example using electron micrographs.

The particles form a matrix (capsule) in which the substances to be encapsulated are embedded. The solid wax-like matrix is mechanically stable and protects the embedded substances against chemical and/or physical damage, for example against oxidation or damage by UV radiation. It is surprising that the hydrophobic particles with a wax-like substance have high stability and are storage-stable even without a shell, as are present, for example, in the case of the core-shell capsules with a liquid core known from the prior art.

The capsules obtained by the method according to the invention are likewise provided by the present invention. The capsules according to the invention have a maximum diameter of less than 1 μm, preferably of less than 0.5 μm, particularly preferably of less than 0.25 μm. The capsules according to the invention comprise a core which comprises an active ingredient or a detection agent and also one or more hydrophobic substances which are liquid under standard conditions and which are homogeneously mixed with a wax-like substance.

The capsules according to the invention can have a shell.

Preferably, the capsules according to the invention are stored in aqueous dispersion. The present invention therefore further provides an aqueous dispersion comprising wax-containing capsules according to the invention and one or more dispersion auxiliaries.

It is conceivable to adjust the pH of the dispersion in a targeted manner in order to increase the storage stability. Preferably, the dispersion is adjusted to a pH 7, particularly preferably to pH 9-10. This can be achieved for example using suitable buffers.

It is conceivable to replace the water with a different liquid phase, for example with alcohols, such as ethanol or methanol. It is likewise conceivable to remove the water by customary methods such as, for example, spray-drying, and to store the capsules dry.

It is conceivable to surround the capsules according to the invention with a shell. As explained above, a shell is not absolutely necessary with regard to a mechanical stability of the capsules. Nevertheless, an additional shell can have a positive influence on the storage stability by further reducing possible agglomeration of the particles. A shell can, moreover, be advantageous in order to constitute e.g. a diffusion barrier for the enclosed active ingredient and thus to achieve a time-related release profile or in order to form a barrier for substances (e.g. water or oxygen) which could lead to damage of the encapsulated substance.

Furthermore, it was surprisingly found that a shell considerably improves the adhesion of capsules according to the invention to certain substrates. If polymeric surfaces are treated with aqueous dispersions of capsules according to the invention having a polymeric shell, then these capsules preferentially adhere to this surface. For example, capsules according to the invention having a polymer shell made of cyanoacrylate exhibit a good adhesion to polyester materials. It is thus conceivable to load macroscopic surfaces with active ingredient particles in order to achieve a release of the active ingredient there over a prolonged time.

In a preferred embodiment, the capsules according to the invention have a shell.

Preferably, the capsules according to the invention are provided with a polymer shell, particularly preferably with a shell made of polyalkyl cyanoacrylate. The alkyl radical of the polyalkyl cyanoacrylate is preferably a C₁-C₈-chain. The shell particularly preferably consists of polymethyl cyanoacrylate, polyethyl cyanoacrylate, polypropyl cyanoacrylate, polybutyl cyanoacrylate or a mixed polymer of said polyalkyl cyanoacrylates.

In a preferred embodiment, the method according to the invention for producing stable capsules thus comprises the further step
(f) coating of the capsules with a polymer shell.

Step (f) is carried out after step (d) or (e). Preferably, step (f) is carried out after step (e). It is conceivable to carry out step (f) also even after storage of the non-coated capsules over a period of hours, days or months.

The polymer shell is preferably built up by polymerization in the aqueous dispersion of the capsules at the phase interfaces aqueous solution/capsules.

For this purpose, it is possible to use those monomers which preferably polymerize at the phase interface. It is also possible to use monomer mixtures. Preference is given to using n-alkyl cyanoacrylates.

Preferably, the monomers are added in a suitable solvent to the aqueous phase. Suitable solvents for alkyl cyanoacrylates are, for example, methanol, ethanol, acetone, dichloromethane, chloroform, isopropanol, tetrahydrofuran. Preferably, acetone is used.

The solvent is preferably “acidified”, i.e. admixed e.g. with an amount of from 0.01 to 10% by weight of hydrochloric acid in order to prevent a premature reaction of the monomer.

The concentration of the monomer in the solvent is usually in the range from 0.1 to 10% by weight.

The polymerization can take place at room temperature (10-30° C..). It may likewise be useful to carry out the reaction at a lower or higher temperature. A lower temperature may be useful e.g. in order to prevent secondary reactions. A higher temperature may be useful e.g. in order to increase the rate of the reaction.

Depending on the monomers used, it may be useful to use a catalyst for increasing the rate of the reaction and/or for activation. For increasing the rate of the reaction, functional groups such as polyethers or hydroxyl functions, for example, also contribute.

The use of electromagnetic radiation for initiating and/or increasing the rate of the polymerization may also be useful depending on the monomer used.

The coated capsules according to the invention exhibit a significantly higher stability and improved adhesion compared with the core-shell capsules known from the prior art having a liquid core.

The invention is illustrated in more detail below by reference to examples, without, however, limiting it thereto.

### EXAMPLE 1

### Capsules Comprising Deltamethrin Without Wax-Like Substance (Comparative Example)

100 g of Solvesso 200, in which 10% by weight of deltamethrin (3-(2,2-dibromoethenyl)-2,2-dimethyl-cyclopropane) have been dissolved, and 300 g of aqueous phase, in which 1% by weight of Synperonic F68 have been dissolved and adjusted to pH 7 with buffer, were firstly emulsified using an Ultraturrax to give an oil-in-water emulsion. The Ultraturrax was then replaced by a stirrer at 1000 rpm. With stirring, 22.5 g of a mixture of ethanol and 1 N HCl (ratio 1000:1) and 1.8 g of ethyl cyanoacrylate were added dropwise and the mixture was after-stirred for one hour.

### EXAMPLE 2

Capsules Comprising Deltamethrin with Beeswax

400 g of aqueous phase, in which 0.5% by weight of Synperonic F68 have been dissolved and adjusted to pH 7 with buffer, were heated to ca. 60° C.. in a hot water bath. Then, 22.5 g of Solvesso 200, in which 10% by weight of deltamethrin and 10% by weight of beeswax have likewise been dissolved in the hot water bath, were emulsified therein using an Ultraturrax to give an oil-in-water emulsion. The Ultraturrax was then replaced by a stirrer at 300 rpm. With stirring, 22.5 g of a mixture of ethanol and 1 N HCl (ratio 1000:1) and 1.8 g of ethyl cyanoacrylate were added dropwise and after-stirred for 30 minutes. The mixture was then cooled to room temperature using a cold water bath.

### EXAMPLE 3

Capsules Comprising Flumethrin with Beeswax

200 g of aqueous phase, in which 2% by weight of Disperbyk 192 have been dissolved and adjusted to pH 7 with buffer, were heated to ca. 60-70° C. in a hot water bath. Then, 11.25 g of Miglyol 812, in which 20% by weight of flumethrin and 10% by weight of beeswax have likewise been dissolved in the hot water bath, were emulsified therein using an Ultraturrax to give an oil-in-water emulsion and then the mixture was rapidly cooled to room temperature. The Ultraturrax was then replaced by a stirrer at 300 rpm. With stirring, 11.25 g of a mixture of ethanol and 1 N HCl (ratio 1000:1) and 1.8 g of ethyl cyanoacrylate were added dropwise and the mixture was after-stirred for one hour. The particle size was determined by means of transmission electron microscopy (TEM). The diameter of the capsules is in the range 80-150 nm

The dispersion was then stored at room temperature for 6 months and at 40° C. for 4 weeks. Within this period, the sample remained stable, i.e. no agglomeration of the particles, no change in the particle size and no escape of active ingredient or core matrix were observed.

### EXAMPLE 4

Capsules Comprising Flumethrin with Beeswax 100 g of aqueous phase, in which 30% by weight of Disperbyk 192 have been dissolved and adjusted to pH 10 with buffer, were heated to ca. 60-80° C. in a hot water bath. Then, 11.2 g of Miglyol 812, in which 10% by weight of flumethrin (alpha-cyano(4-fluoro-3-phenoxy)benzyl-3-[2-chloro-2-(4-chlorophenyl)ethenyl]-2,2-dimethylcyclopropanecarboxylate) and 10% by weight of beeswax have likewise been dissolved in the hot water bath, were emulsified therein with stirring. 10 g of this mixture were diluted with a 10-fold amount (100 g) of water adjusted to pH 9 and, with vigorous stirring, 10 g of a mixture of acetone and 10% strength by weight hydrochloric acid (ratio 500:1) and 0.4 g of ethyl cyanoacrylate were added dropwise. Then, at 40° C., excess acetone was removed on the rotary evaporator. Finally, for the purposes of stabilization, buffer 10 borate (Fisher Scientific) was added.

The particle size was determined by means of TEM in negative staining. The diameter of the capsules is in the range from 50-120 nm.

### EXAMPLE 5

Capsules Comprising Deltamethrin with Beeswax

100 g of aqueous phase, in which 30% by weight of Disperbyk 192 have been dissolved and adjusted to pH 10 with buffer, were heated to ca. 60-80° C. in a hot water bath. Then, 11.2 g of Miglyol 812, in which 10% by weight of deltamethrin and 10% by weight of beeswax have likewise been dissolved in the hot water bath, were emulsified therein with stirring.

10 g of this mixture were diluted with a 10-fold amount (100 g) of water adjusted to pH 9 and, with vigorous stirring, 20 g of a mixture of acetone and 10% strength by weight hydrochloric acid (ratio 500:1) and 0.8 g of ethyl cyanoacrylate were added dropwise. Then, at 40° C., excess acetone was removed on the rotary evaporator. Finally, for the purposes of stabilization, buffer 10 borate (Fisher Scientific) was added.

The dispersion (buffered and unbuffered) was then stored at room temperature and at 40° C. for 2 weeks. Within this period, the buffered sample (at RT and 40° C.) and also the unbuffered sample (at RT) remained stable, i.e. no agglomeration of the particles, no change in the particle size and no escape of active ingredient or core matrix were observed. By contrast, the unbuffered sample stored at 40° C. exhibited the beginnings of sedimentation of the particles.

### EXAMPLE 6

Capsules Comprising Deltamethrin with Cetyl Alcohol 100 g of aqueous phase, in which 30% by weight of Disperbyk 192 have been dissolved, were heated to ca. 80-90° C. in a hot water bath. Then, 14.9 g of Miglyol 812, in which 10% by weight of deltamethrin and 10% by weight of cetyl alcohol have likewise been dissolved in the hot water bath, were emulsified therein with stirring.

12.8 g of this mixture were diluted with 100 g of water and, with vigorous stirring, 20 g of a mixture of acetone and 10% strength by weight hydrochloric acid (ratio 500:1) and 0.2 g of ethyl cyanoacrylate were added dropwise. Then, at 40° C., excess acetone was removed on the rotary evaporator.

The dispersion was then stored at room temperature, at 40° C. and at 60° C. for 4 days. Within this period, the samples at room temperature and at 40° C. remained stable, i.e. no agglomeration of the particles, no change in the particle size and no escape of active ingredient or core matrix were observed. At 60° C., slight deposits were visible at the edge; the majority of the dispersion, however, likewise remained stable.

1. Method for producing stable capsules, comprising the steps of:
(a) providing a first component, comprising a solid wax-like substance,
(b) providing a second component, comprising a substance to be encapsulated, dissolved or dispersed in a liquid medium,
(c) homogeneously mixing the first and second components,
(d) dispersing the mixture from step (c) in an aqueous solution at a temperature above the melting temperature of the wax-like substance using at least one dispersion auxiliary, to form an emulsion,
(e) cooling and diluting the emulsion from step (d).

2. Method according to claim 1, wherein the wax-like substance is selected from the group consisting of paraffin, fatty alcohol, fatty acid, fatty acid esters, fatty acid ethers, polyethylene wax, montan wax, polyether wax, beeswax, cetyl montanic acid esters and combinations thereof.

3. Method according to claim 1, wherein said substance to be encapsulated is an active ingredient or a detection agent.

4. (canceled)

5. Method according to claim 1, wherein said dispersion auxiliary is a polyoxyethylene-polyoxypropylene block copolymer.

6. Method according to claim 1, comprising the further step of
(f) coating of the capsules with a polymer shell.

7. Method according to claim 7 wherein the polymer shell is built up by polymerization in the aqueous dispersion of the capsules at the phase interfaces aqueous solution/capsules.

8. Capsules comprising at least one wax-like substance and one substance to be encapsulated and also one or more hydrophobic substances which are liquid under standard conditions and which are homogeneously mixed with the wax-like substance, wherein the capsules have a maximum diameter of less than 1 μm, and the substance to be encapsulated is an active ingredient or a detection agent.

9. Capsules according to claim 8, further comprising a polymer shell.

10. Capsules according to claim 9, wherein the polymer shell consists of polyalkyl cyanoacrylate.

11. Aqueous dispersion, comprising capsules of claim 8 and at least one dispersion auxiliary.

12. Method for increasing the mechanical and/or chemical stability of capsules and/or encapsulated substances which comprises including a wax-like substance in the capsules or encapsulated substances.

13. Capsules of claim 8 wherein the substance to be encapsulated comprises one or more active ingredients or one or more detection agents.

14. The method of claim 1, wherein said emulsion is a microemulsion.
